(19) United States
(12) Patent Application Publication
(10) Pub. No.: US 2017/0336025 A1
(43) Pub. Date: Nov. 23, 2017

(54) BALL RETURN SYSTEM AND RELATED FEATURES

(71) Applicant: QubicaAMF Worldwide, LLC, Mechanicsville, VA (US)

(72) Inventors: LeRoy Thomas Warren, Jr., Richmond, VA (US); Charles Anton Lee, Williamsburg, VA (US); Patrick Reitelbach, Bumpass, VA (US)

(21) Appl. No.: 15/671,658

(22) Filed: Aug. 8, 2017

Related U.S. Application Data
(63) Continuation of application No. 14/605,196, filed on Jan. 26, 2015.
(60) Provisional application No. 61/931,142, filed on Jan. 24, 2014.

(51) Int. Cl. F16P 1/02; A63D 5/02

(52) U.S. Cl. CPC F16P 1/02; A63D 5/023; Y10T 74/219

(57) ABSTRACT

A ball lift assembly includes: a housing having an entrance and an exit; a motor which drives a ball lift system; an electronic control unit (ECU); and a plurality of sensors providing signals to the electronic control unit, including: a first sensor which detects a ball entering the lift system through the entrance; and a second sensor which detects the ball exiting the lift system through the exit. The first sensor provides a first signal to the ECU when the first sensor detects the ball entering the lift system through the entrance. The second sensor provides a second signal to the ECU when the second sensor detects the ball exiting the lift system through the exit. The ECU will turn on the motor to drive the ball lift system upon receiving the first signal, and turn off the motor of the ball lift system soon after receiving the second signal, while making sure the ball actually exits the unit.

### FIELD OF THE INVENTION

The invention relates to a ball return system and more specifically to a ball return lift system with related safety and mechanical features.

### BACKGROUND

Ball return systems are machines used in a bowling environment for returning a bowling ball to a bowler. Common to each of the known devices is some means by which the bowling ball enters a lifting device, is lifted to a desired level, and then is ejected from the device to a ball rail system to a waiting bowler.

### SUMMARY OF INVENTION

In an aspect of a ball lift assembly, comprising any combination of: a first sensor that detects a ball entering the ball lift assembly and turns on the ball lift assembly when the ball enters; a second sensor that detects a ball exiting the ball lift assembly and turns off the ball lift assembly soon after the ball exits; a third sensor that detects an object, e.g., hand, entering into the ball lift assembly from an exit side thereof, the third sensor turns off the ball lift assembly when the object enters from the exit side thereof; a control unit that controls the turning on and off of the ball lift assembly based on the first, second and/or third sensor, the control unit further comprises logic that turns off the ball lift assembly when a ball does not exit therefrom within a predetermined amount of time; a hood that is removable, the hood: mates with a rail system mounted to a surface; and is structured such that there is clear space between an exit of the hood system and one or more moving parts, e.g., wheel, of the ball lift assembly; a stationary/fixed blocking bracket that has a profile complimentary to an upper wheel, thereby preventing objects, e.g., hand, from being drawn into a lifting mechanism; and a removable wear strip provided on a ball rail, the removable wear strip: comprises projections which mate with holes on the ball rail system; and has a profile which matches to the ball rail.

In another aspect of the invention, a ball lift assembly comprises: a housing having an entrance and an exit; a motor which drives a ball lift system to lift a ball from the entrance to the exit; an electronic control unit; and a plurality of sensors providing signals to the electronic control unit, comprising: at least a first sensor positioned adjacent to the entrance and which detects a ball entering the lift system through the entrance; and a second sensor positioned adjacent to the exits and which detects the ball exiting the lift system through the exit. The first sensor provides a first signal to the electronic control unit when the first sensor detects the ball entering the lift system through the entrance. The second sensor provides a second signal to the electronic control unit when the second sensor detects the ball exiting the lift system through the exit. The electronic control unit will turn on the motor to drive the ball lift system upon receiving the first signal. The electronic control unit will turn off the motor of the ball lift system upon receiving the second signal, while also waiting for a predetermined time to make sure the ball exits the lift.

In another aspect of the invention, a removable hood assembly includes: a hood having a first mechanism; a rail system having a second mechanism which mates with the first mechanism such that the hood can be slid in and out with respect to the rails system; and a latch to attach the hood to the rail system.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 shows two plan views of a ball return system in accordance with aspects of the present invention.

FIG. 2 shows an exploded view of a ball return system (ball lift assembly) in accordance with aspects of the present invention.

FIG. 3 shows a partial exploded view of a ball return system in accordance with aspects of the present invention.

FIG. 4 shows a perspective view of a ball rail system in accordance with aspects of the present invention.

FIGS. 5a and 5b show a wear strip of the ball rail system in accordance with aspects of the present invention.

FIGS. 6a and 6b shows a hood system and ball rail system in accordance with aspects of the present invention.

FIG. 7 shows partial cut-away view of the hood system and ball lift assembly and related mechanisms of the ball return system in accordance with aspects of the present invention.

FIG. 8 shows an exploded view of the hood system in accordance with aspects of the present invention.

### DETAILED DESCRIPTION

The invention relates to a ball return system and more specifically to a ball lift assembly with related safety and mechanical features and components. The ball return system is a compact, safe, stylish and sophisticated solution to existing systems. The ball return system provides the following features, in addition to those provided in the accompanying figures and described further herein.

Ergonomic Design

The ergonomic design of the ball return system has many advantages. For example, from a safety standpoint, the design of the system will keep the customer's hands away from any moving parts. More specifically and as described in greater detail herein, the design of the hood component and related mechanisms is unique in the way it prevents the bowler or other person from reaching in deep into the area where the ball exits from the ball lift rails and onto the track of the ball rack. That is, the safety aspect of the invention is inherent to the shape of the exit portion of the hood unit; that is, the hood has an overhang which prevents insertion of a hand into the mechanisms. Also in addition there is a unique fixed/stationary blocking bracket that prevents a person's hand from being hurt when the unit is in a maintenance mode, which protects the mechanic/authorized technician.

Opto-Electronic Sensing Technology

The Opto-Electronic Sensing Technology improves energy efficiency and safety. By implementing the sensor technology of the present invention, the motor will run only when the ball arrives; otherwise the motor will stop if hands or objects are inserted into the hood unit or near other mechanisms which are being monitored by the sensors. In embodiments, the sensor technology includes at least two sensors: 1) a sensor which detects the ball entering the lift and which is positioned under the lane or other entry point of the ball lift assembly. This is what starts the lift and allows the motor to save power by turning on only when needed; and 2) another sensor that provides an output if any object enters the hand intrusion area and allows the motor and hence the risk to be eliminated. Another sensor may be used to also detect when the ball has exited the system in order to turn off the motor, or determine that a jam may exist in the lift assembly if a ball has not exited within a predetermined time period. Logic is designed to handle the various operational modes of operation as further described herein.

Compact Design:

The compact design of the system provides for minimal congestion and more space on the approach of the bowling lane. In embodiments, the compact design includes the design of the ball rack which is unique in that it is designed to hold 12 balls but also designed to be narrower than other known systems (which typically accommodate side by side balls and hence is wider than at least two balls and a related rail system). This helps the bowler get maximum room in the bowler approach area beside the ball return. The design of the ball rack also enhances the smart path return and makes the transition from the ball lift to the ball return tray as well as the tray downward to the ball rack side rail very gentle to minimize wear to all areas. The tubular rails of the design also incorporate a unique wear strip that is designed to be replaceable and the design of a urethane rivet for optimum balance of ease of assembly and fit during use. Also the attachment of the lift and the ball return to each other is unique and minimizes the vibration.

Ball Lift Enhancements:

The ball lift enhancements include a ball track which is an extension of the ball lift track where the flat track design has been adapted to a different height which is slightly higher than the profile and significantly slower than any other ball lift; that is, in embodiments, the height may be substantially the same as the lift mechanism. This also minimizes the harshness, vibration and the speed of ball exiting the unit. Moreover, the ball lift mechanism provides many additional advantages, including: 1) a chain drive which does not need tensioning, and which is used to run 2 V-wheels which are connected by a cross-over belt; and 2) a quick access hood system for easy maintenance. As to this latter feature, a track system associated with the hood allows ease of installation by permitting the hood to slide in and out. The hood can be fastened by a latch design as described further herein.

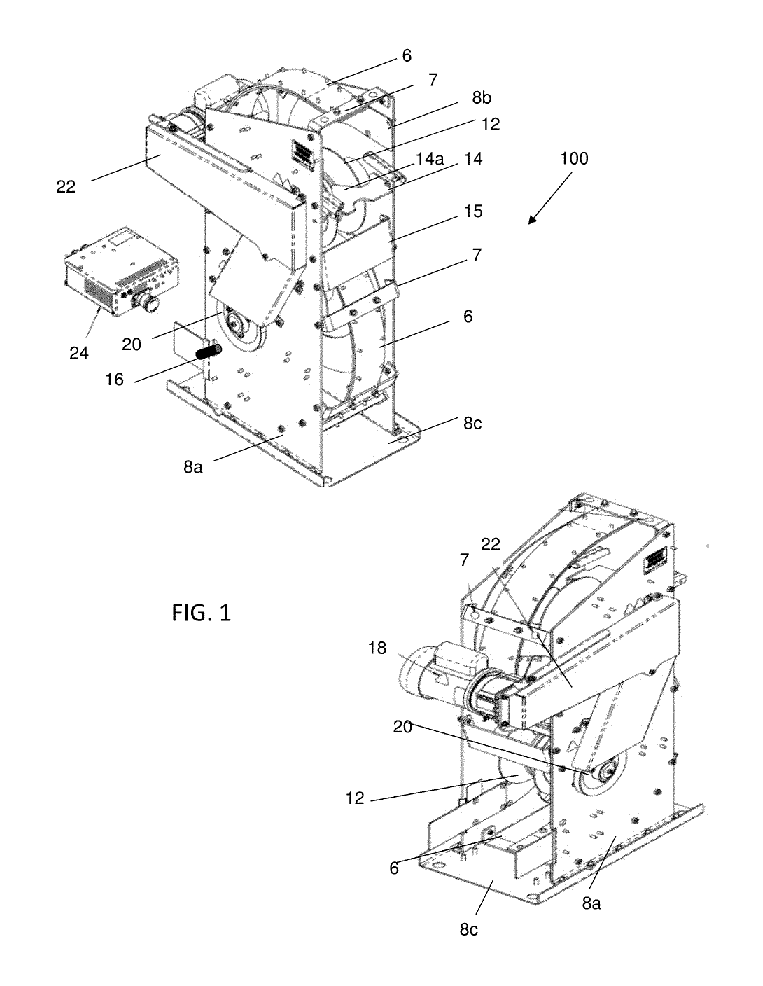

FIG. 1 shows a plan view of a ball lift assembly in accordance with aspects of the present invention. In particular, the ball lift assembly 100 includes frame members 8a, 8b and 8c. In embodiments, the frame members 8a, 8b are side frame members, and frame member 8c is a bottom plate member. Guide rails 6 are provided between the frame members 8a, 8b, held in place by brackets 7 attached (e.g., bolted, screwed, etc) to respective frame members 8a, 8b. In embodiments, the guide rails 6 will guide a bowling ball through the lift system. In embodiments, the guide rails 6 will be curved to have a substantially same profile as the diameter of the wheel(s) 12 and will be spaced apart from the wheel(s) 12 by such a distance so as to allow a ball to pass between the guide rails 6 and the wheel(s) 12. In embodiments, the wheel(s) 12 have a non-planar profile and preferably a v-shaped profile.

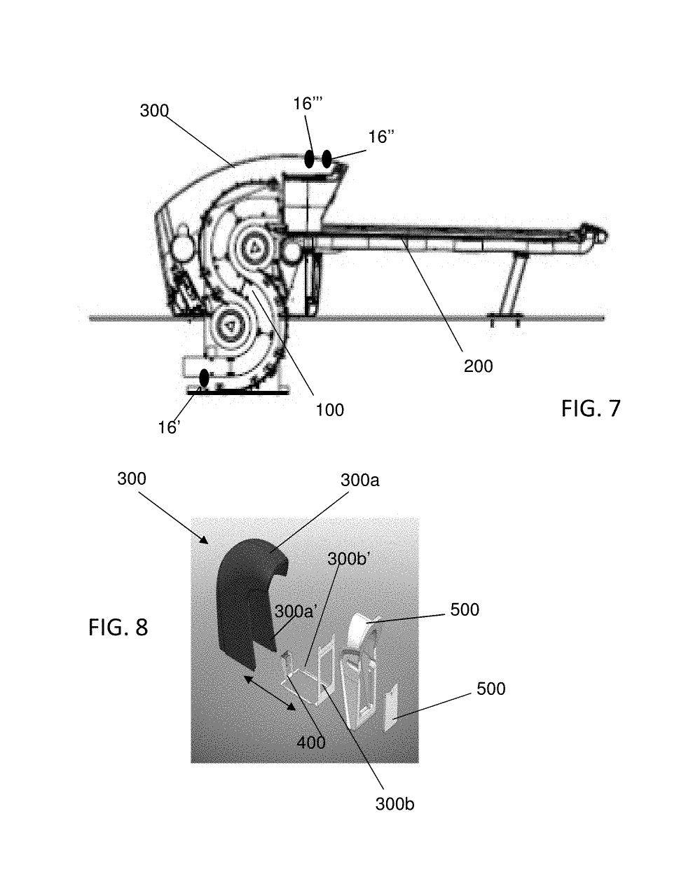

Still referring to FIG. 1, the ball lift assembly 100 further includes a fixed/stationary safety bracket 14 which has a profile 14a that matches (complimentary) the profile of the wheel 12, e.g., non planar and preferably v-shape. This bracket 14 will block or prevent objects, e.g., hands, from being caught in the wheel during maintenance, e.g., when hood is off, or if someone accidently reaches too far into the ball lift assembly 100, e.g., under a hood, to grab a ball during the bowling game. The hood system and related mechanisms of the ball lift assembly are described with reference to at least FIGS. 7 and 8.

The ball lift assembly 100 further includes one or more brackets 15. The one or more brackets 15 can be attached, e.g., bolted, screwed, etc., to the frame members 8a, 8b.

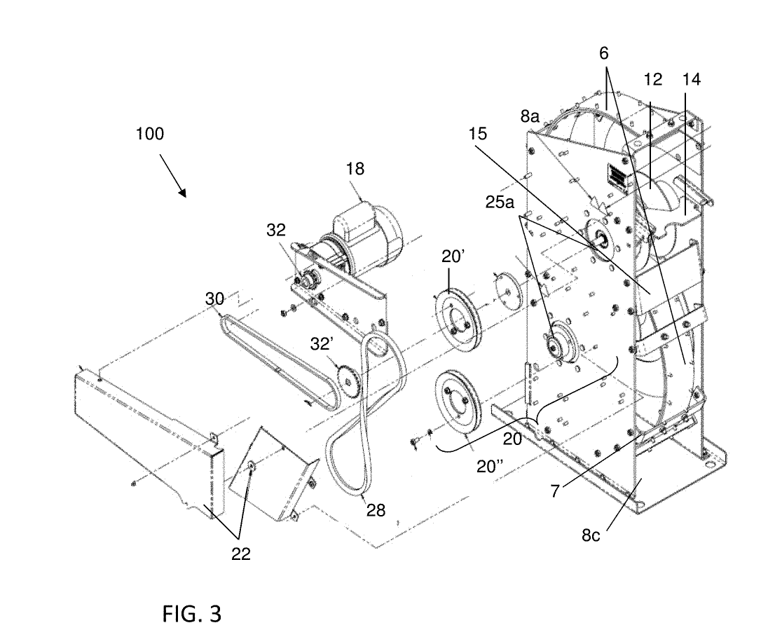

The ball lift assembly 100 further includes a plurality of sensors 16. In embodiments, the sensors can be opto-electronic sensors, such as motion detectors. By breaking a light or other sensing technology known to those of skill in the art, the sensors 16 can detect when a ball is arriving/entering into the ball lift assembly 100, and particularly when the ball is about to contact the bottom wheel 12 or be lifted onto the bottom guide rail 6. Once detected, the sensor 12 will activate the ball lift assembly 100, e.g., motor 18, in order for the ball to be lifted onto the bottom guide rails 6 and/or wheel combination. As shown and described more specifically with reference to FIG. 3, the motor 18 can drive a set of pulleys and belts (drive and driven system), generally shown at reference numeral 20. The set of pulleys and belts, in turn, will rotate the wheels 12. In embodiments, a guard 22 can be used to protect the set of pulleys and belts, as well as act as a safety feature to ensure that a person's hands cannot get caught in the set of pulleys and belts during maintenance.

FIG. 1 further shows an electronic control unit 24. In embodiments, the electronic control unit 24 unit will turn on and off (e.g., activate) the ball lift assembly 100, e.g., motor 18. In further embodiments, the electronic control unit 24 includes logic such as a timer which can shut down the ball lift assembly 100 in a predetermined amount of time if a ball is not detected to exit the lift assembly 100, e.g., the time it should take the ball to navigate the entire system. This timer will act as a safety feature, e.g., if the ball does not exit from the system in the allotted time, the electronic control unit 24 will shut down the system under the assumption that the ball is stuck or otherwise remains in the ball lift assembly 100. Logic of the electronic control unit 24 is designed to handle the various operational modes.

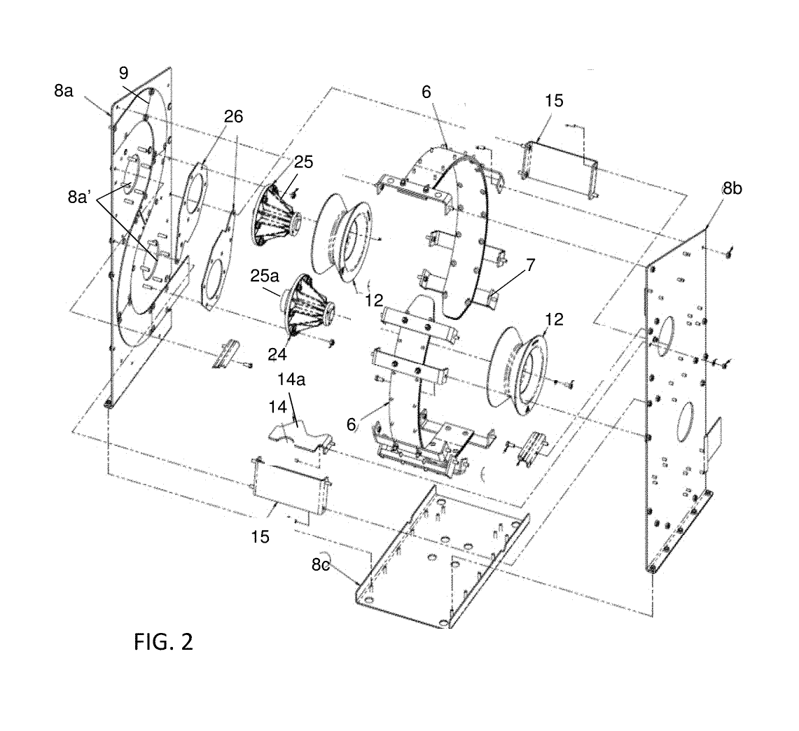

FIG. 2 shows an exploded view of the ball lift assembly 100 in accordance with aspects of the invention. As shown in FIG. 2, the guide rails 6 are substantially U-shaped and have a curved substantially similar to the profile of the diameter of the wheel(s) 12. The wheels 12 can be rotatably positioned within the housing and more particularly between the frame members 8a and 8b by a plate assembly 25. In embodiments, the plate assembly 24 will have a rotatable shaft 25a extending from the wheels 12 and extending through an opening 8a′ of the frame member 8a.

As shown in FIG. 3, for example, the rotatable shaft 25a will engage a pulley system 20 in order to control rotation of the wheels 12. In embodiments, a spacer plate 26 can be positioned between the plate assembly 24 and the frame member 8a. The frame members 8a, 8b also include a serpentine structure 9, which matches to the positioning of the guide rails 6.

FIG. 3 shows a partial exploded view of a ball lift assembly 100 in accordance with aspects of the present invention. As shown in this representative view, the pulley system 20 of the ball lift assembly 100 includes a top pulley 20′ and a bottom pulley 20″. In embodiments, the pulleys 20′, 20″ are attached or coupled to shafts 25a, extending outwardly from the openings 8a′ of the frame member 8. In embodiments, the top pulley 20′ drives the top wheel 12′ in a clockwise direction; whereas, the bottom pulley 20″ drives the bottom wheel (not shown) in a counterclockwise direction. This bottom pulley 20″ is driven by the belt 28, which is in a FIG. 8 configuration. The top pulley 20′, on the other hand, is driven by a drive chain 30 that connects a sprocket 32 of the motor 18 to sprocket 32′ of the drive top pulley 20′. In this way, the drive chain 30 drives the top pulley 20′ in order to rotate the wheel(s) 12′. Advantageously, the drive chain 30 also eliminates the need for a tensioner for the belt 28 since there is a direct connection between the motor 18 and the upper pulley 20′ (via the sprockets).

Still referring to FIG. 3, the belt 28 is a V-shape belt. This belt 28 is provided in a FIG. 8 configuration and is twisted so that the v-profile will match to each of the top and bottom pulleys 20′, 20″. The FIG. 8 configuration and the twist also allows the bottom pulley 20″ to rotate in a counterclockwise direction; whereas, the upper pulley (driven by the belt chain 30) is rotated in the clockwise direction. The guard 22 can be an assembly of plates attached to the frame member 8a (e.g., bolted, screwed, etc.), and used to protect the set of pulleys and belts, as well as act as a safety feature to ensure that a person's hands cannot get caught in the set of pulleys and belts during maintenance.

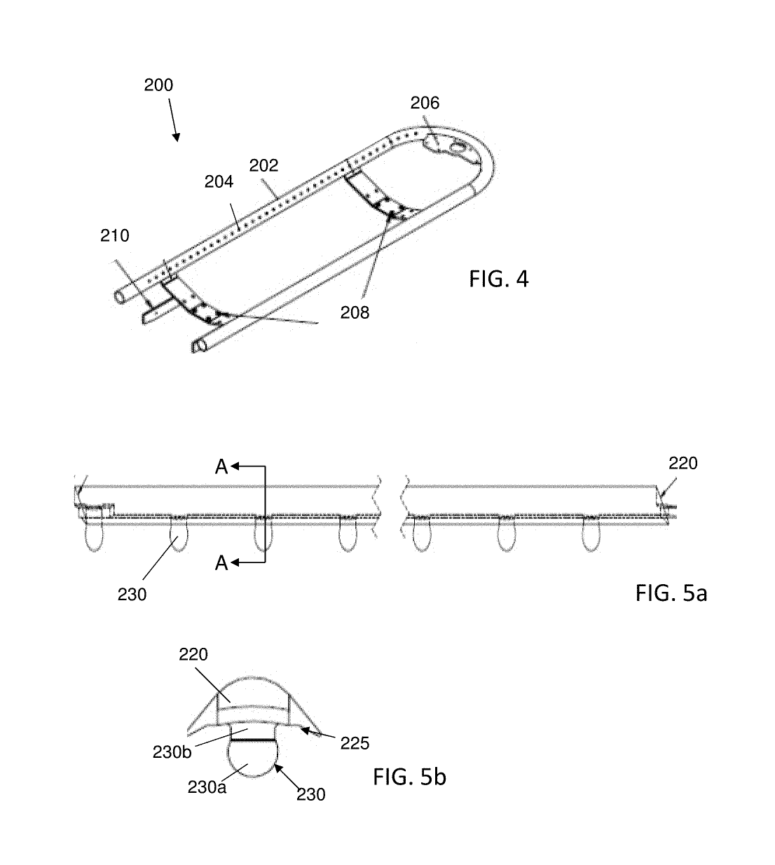

FIG. 4 shows a perspective view of ball rail system in accordance with aspects of the present invention. In FIG. 4, the ball rail system 200 includes a ball rack (rail) 202 with a plurality of holes (openings) 204. In embodiments, the ball rack 202 is a tubular structure, and the holes 204 are used to accommodate rivets or protrusions of a wear strip as described with reference to FIG. 5. The plurality of holes 204 extend along at least a length of the ball rack (rail) 202.

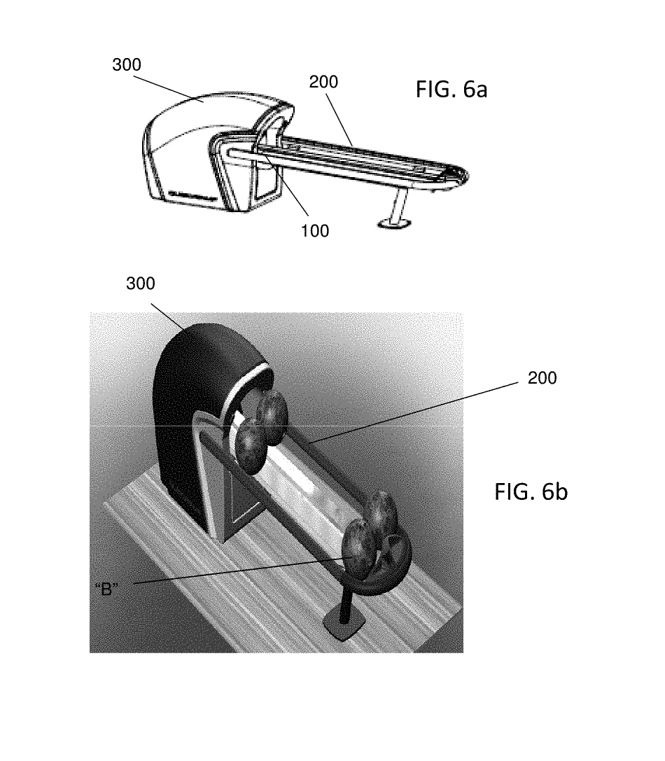

In embodiments, the ball rack 202 is designed to hold 12 balls but is also designed to be narrower (e.g., about 20 inches) than other known lifts to help the bowler get maximum room in the bowler approach area beside the ball return system. The ball rail system 200 further includes an end stop plate 206 and a plurality of brackets 208. A ball rack connector bracket 210 extends from one of the brackets, in order to connect to the ball lift assembly 100 as shown in FIGS. 6 and 7. The attachment to the hood assembly minimizes any vibration that could transfer from the ball lift mechanism.

FIGS. 5a and 5b show a wear strip 220 of the ball rail system 200 in accordance with aspects of the present invention. More specifically, FIG. 5a shows a plan view of the wear strip 220; whereas, FIG. 5b shows a partially cut-away view along line A-A of FIG. 5a. In embodiments, the wear strip 220 can be a urethane type material, which is removable from the ball rack 202. The wear strip 220 can also be other durable materials such as, nitrile rubber, etc.

The wear strip includes a profile 225, e.g., concave, which will match to that of the ball rail system 200 and more specifically the tubular structure of the ball rack 202. This configuration ensures that the wear strip fits snugly onto the tubular structure of the ball rack 202; although other profiles are also contemplated by the present invention. The wear strip 220 further includes a protrusion or rivet 230 protruding from the wear strip 220. The protrusion 230 mates with the holes 204 of the ball rack 202, allowing the wear strip 220 to be easily removed and replaced.

As shown, the end or bulbous portion 230a of the protrusion 23Q is connected to the wear strip 220 by a narrower neck portion 230b. The bulbous portion 230a of the protrusion 230 is slightly larger than a diameter of the holes 204 of the ball rack 202. During the assembly process, the bulbous portion 230a of the protrusion 230 will deform as it enters the holes 204 and will then return to its original shape in order to securely hold the wear strip 220 to the ball rack 202.

FIGS. 6a and 6b show a hood system and ball rail system in accordance with aspects of the present invention. As shown in FIG. 6a, a hood assembly 300 covers the ball lift assembly 100. In embodiments, the hood assembly 300 is a removable assembly as described with respect to FIG. 8. As shown, the hood assembly 300 includes a large overhang, positioned away from the upper wheel that conveys the ball onto the ball rail system 200. This overhang ensures that a person reaching for the ball cannot accidently contact the wheel or other moving parts of the ball lift assembly 100. By way of example, the overhang is positioned away from a vertical wall forming the exit of the system, and can be any distance which prevents the possibility of being able to contact any moving parts within the ball lift assembly, e.g., the wheels 12.

FIG. 6b, 4, 5a, 5b shows a plurality of balls “B” on the ball rail system 200 and more specifically the wear strip 220 that is attached to an inner portion of the ball rack 202. The design of the ball rail system 200 also makes the transition from the ball lift assembly 100 to the ball return and the tray very gentle to minimize wear to all areas.

FIG. 7 shows a cut-away view of the hood system and related mechanisms of the ball return system in accordance with aspects of the present invention. More specifically, FIG. 7 shows the combination of the ball lift assembly 100, the ball rail system 200 and the hood assembly 300. As shown in FIG. 7, the ball lift assembly 100 includes a plurality of sensors 16′, 16″ (e.g., optical sensors). The sensors 16′, 16″ detect when an object will enter or exit the ball lift assembly 100. For example, the sensor 16′ will detect when a ball is entering the ball lift assembly 100, at which time the sensor 16′ will provide a signal to the electronic control unit which, in turn, will activate the motor. On the other hand, the sensor 16″ can detect when the ball is exiting the system. Thus, as the ball is exiting the ball lift assembly 100, a signal can then be sent to the electronic control unit to deactivate the motor thus saving energy. In this way, the motor is turned on only when needed, thus saving a considerable amount of energy.

In more specific embodiments, as the sensor 16′ detects the ball entering the ball lift assembly 100, a timer can be activated. The timer can then be deactivated when the ball is detected leaving the ball lift assembly 100 by the sensor 16′. That is, once the ball is detected exiting the ball lift assembly 100, a “ball stuck in lift” error flag in the electronic control unit can be turned OFF, placing the motor in a ready waiting mode for the next ball. The motor will turn on when another ball is detected.

In additional embodiments, if the ball does not exit the ball lift assembly 100 within a predetermined time period, the electronic control unit will assume that the ball is stuck or that there was a malfunction of the ball lift assembly 100. If this is the case, the motor will be shut down so that a maintenance person can attend to the malfunction or jammed ball. More specifically, in the event that the ball does not exit the ball lift assembly 100 within a predetermined period of time (e.g., the amount of time in which the ball should have traversed the system), the “ball stuck in lift” flag can be turned ON, and the motor will be shut off. An alarm can then sound, alerting the maintenance worker to attend to the ball lift assembly 100. Thus, the motor can run for a predetermined time period, and shut off when the sensor detects the exiting ball or if the predetermined time period has passed (in which the ball should have exited the system).

In further embodiments, an additional sensor 16′″ can also detect when an object, e.g., hand, etc., is placed under the hood 300, e.g., entering the ball lift assembly 100. Once an object is detected, the motor is turned off and the wheels will stop rotating. This will prevent injury from a moving part.

FIG. 8 shows an exploded view of the hood system 300 in accordance with aspects of the present invention. The hood assembly includes a hood 300a which is easily removed by gliding on a track/rail system 300b mounted to the floor. The track/rail system includes lips 300b′ which mate with grooves 300a′ on the underside of the hood 300a, or vice versa. This track system allows the hood to easily slide in and out for ease of removal and assembly. In embodiments, the hood 300a can be fastened to the track/rail system 300b and/or the ball lift assembly 100 by latch 400. A bezel 500 can be provided on a front facing portion of the hood 300a.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A ball lift assembly, comprising:
a wheel assembly having at least one wheel;
a hood that covers the wheel assembly, the hood having an exit opening that allows exit of bowling balls from the hood; and
at least one non-contact opto-electrical sensor positioned adjacent to the exit opening of the hood, the at least one non-contact opto-electrical sensor detects an object entering the exit opening of the removable hood and provides an output signal to an electronic control logic, wherein:
the electronic control unit controls the turning off of the wheel assembly based on the output signal from the at least non-contact opto-electrical sensor that signifies an object is passing into the exit opening of the hood, and
the at least one non-contact opto-electrical sensor is a motion detector that detects motion of the object as it enters the exit opening as it moves past the least one non-contact opto-electrical sensor.

2. The ball lift assembly of claim 1, further comprising:
a motor which drives the wheel assembly that lifts a ball from an entrance to the exit opening of the hood,
wherein the electronic control unit turns off the motor upon receiving the output signal from the at least one non-contact opto-electrical sensor.

3. The ball lift assembly of claim 1, wherein the object enters the ball exit in a direction different than the bowling balls being ejected therefrom.

4. The ball lift assembly of claim 1, further comprising a rail assembly configured to receive the ball as it exits from the exit opening.

5. The ball lift assembly of claim 1, wherein the wheel assembly is a plurality of wheels positioned in a vertically offset position.

6. The ball lift assembly of claim 1, wherein the hood is a removable hood.

7. A sensor unit of a ball lift assembly, comprising:
at least one non-contact opto-electrical sensor positioned adjacent to an exit opening of a hood of the ball lift assembly, the at least one non-contact opto-electrical sensor detects an object entering the exit opening of the hood and provides an output signal to an electronic control logic,
the electronic control unit controls the turning off of the ball lift assembly based on the output signal from the at least non-contact opto-electrical sensor, and
the at least one non-contact opto-electrical sensor is a motion detector that detects motion of the object as it enters the exit opening as it moves past the least one non-contact opto-electrical sensor.

8. The sensor unit for the ball lift assembly of claim 7, wherein the electronic control unit controls the turning off of at least one ball lift wheel of the ball lift assembly.

9. The sensor unit for the ball lift assembly of claim 8, wherein the at least one non-contact opto-electrical sensor is positioned adjacent to an exit opening of a removable hood that covers the at least one ball lift wheel.

10. The sensor unit for the ball lift assembly of claim 7, wherein the electronic control unit controls the turning off a motor that drives a lift mechanism of the ball lift assembly.

11. The sensor unit for the ball lift assembly of claim 10, wherein the lift mechanism is at least one wheel of a wheel assembly.
